(19) United States
(12) Patent Application Publication
(10) Pub. No.: US 2023/0192165 A1
(43) Pub. Date: Jun. 22, 2023

(54) DUAL-WHEELED LEVELING WHEELBARROW

(71) Applicant: Witold S. Macyszyn, Sussex, NJ (US)

(72) Inventor: Witold S. Macyszyn, Sussex, NJ (US)

(21) Appl. No.: 17/554,054

(22) Filed: Dec. 17, 2021

(51) Int. Cl. B62B 1/24; B62B 1/18

(52) U.S. Cl. CPC B62B 1/24; B62B 1/183

(57) ABSTRACT

A dual-wheeled wheelbarrow is disclosed. a first and a second wheel, resiliently connected together via a cable and pully assembly as to have opposingly lateral movement for better handling over uneven ground. One embodiment of the dual-wheeled wheelbarrow includes: a frame, a container connected to the frame, and a first and a second wheel pivotably connected to the frame, wherein the first and second wheel are opposingly pivotable via a control axle and a cable and pully assembly.

### TECHNICAL FIELD

This disclosure relates generally to wheelbarrows and, more particularly, to leveling wheelbarrows.

### BACKGROUND

The statements in this section merely provide background information related to the present disclosure and may not constitute prior art.

Wheelbarrows have long been used to move heavy or bulky items by human propulsion. Conventional wheelbarrows have a wheel rotatably mounted via a single axle to a rigid frame. Dual-wheeled wheelbarrows have both wheels rotably fixed on a shared axle. The frame typically includes a pair of parallel handles for grasping by the user. A tray or bucket is secured to the frame for holding materials to be moved by the wheelbarrow. Once materials are loaded onto the tray, the user grasps and lifts the handles to balance the wheelbarrow on the wheel. The user then pushes the handles to roll the wheel over the ground and move the wheelbarrow to a desired location.

Conventional wheelbarrows lack any leveling. Hence on uneven or sloped ground the wheelbarrow can tip or require considerable effort to keep from tipping.

Accordingly, a need exists for a leveling wheelbarrow.

### SUMMARY

A dual-wheeled wheelbarrow is disclosed. a first and a second wheel, resiliently connected together via a cable and pully assembly as to have opposingly lateral movement for better handling over uneven ground. One embodiment of the dual-wheeled wheelbarrow includes: a frame, a container connected to the frame, and a first and a second wheel pivotably connected to the frame, wherein the first and second wheel are opposingly pivotable via a control axle and a cable and pully assembly.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 shows a dual-wheeled wheelbarrow, in accordance with the present disclosure;

FIG. 2 is a front view of the wheelbarrow, in accordance with the present disclosure;

FIG. 3A is a left, bottom view of the wheelbarrow, in accordance with the present disclosure;

FIG. 3B is a bottom view of the wheelbarrow, in accordance with the present disclosure;

FIG. 3C is a right, bottom view of the wheelbarrow, in accordance with the present disclosure;

FIG. 4 is a cross-sectional view taken along line B-B of FIG. 2, in accordance with the present disclosure;

FIG. 5 is an enlarged cross-sectional view, in accordance with the present disclosure; and

FIG. 6 shows a dual-wheeled wheelbarrow in relation to axis A, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based, in part, on”, “based, at least in part, on”, or “based on” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

The phrase “in one embodiment,” as used herein does not necessarily refer to the same embodiment, although it may. Similarly, the phrase “in some embodiments,” as used herein, when used multiple times, does not necessarily refer to the same embodiments, although it may. As used herein, the term “or” is an inclusive “or” operator, and is equivalent to the term “and/or,” unless the context clearly dictates otherwise.

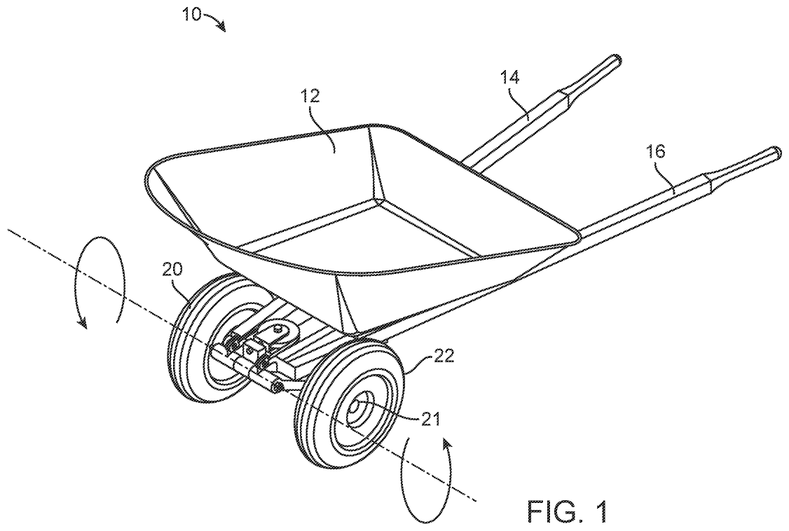

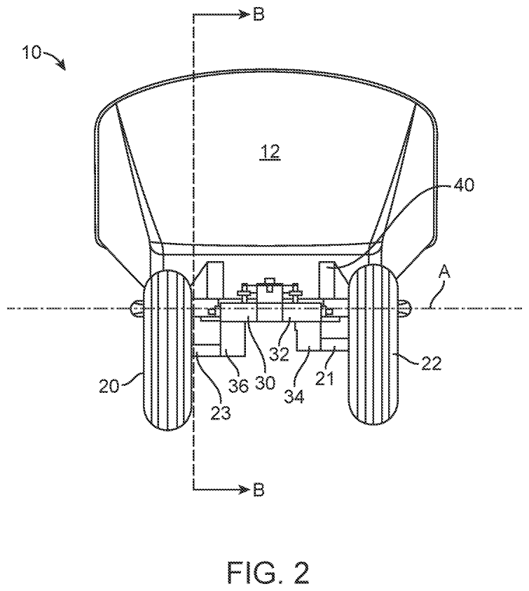

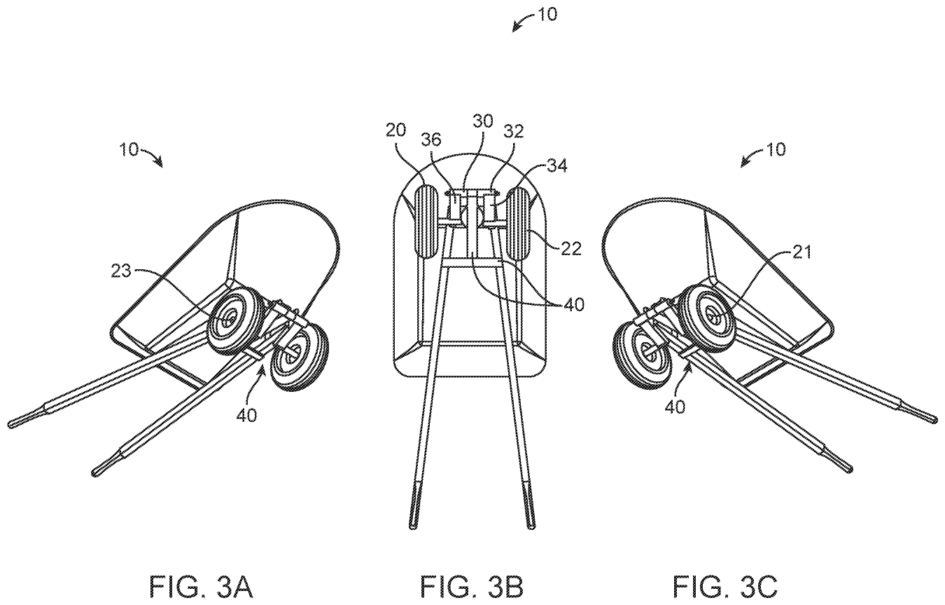

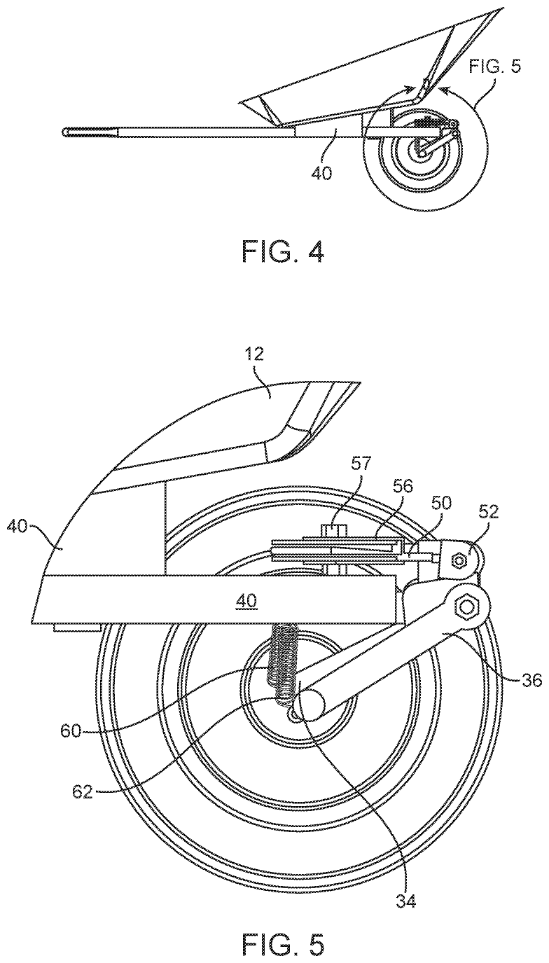

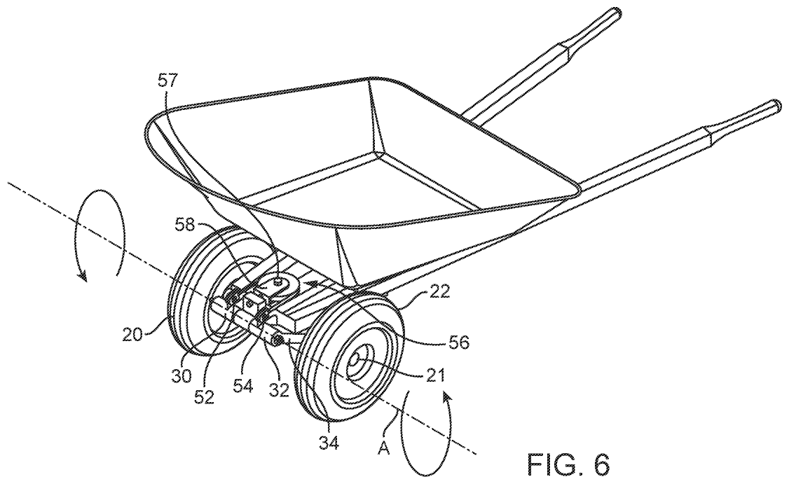

Referring now to the drawings, wherein the depictions are for the purpose of illustrating certain exemplary embodiments only and not for the purpose of limiting the same, FIG. 1 shows an exemplary dual-wheeled wheelbarrow 10. The wheelbarrow 10 includes a container 12 for carrying a load of material, which is removably secured to a frame assembly 40.

The container 12 can include an attachment or mounting bracket for attachment to the frame assembly 40. The container 12 can be secured to the frame 40 by welding or other suitable techniques such as, for example, rivets, bolts or other suitable fastening means. The container 12 can include a substantially flat bottom and a side wall upwardly extending from the edge of the bottom wall to a lip, which forms a top opening. The container 12 then forms an interior space for holding material to be transported by the wheelbarrow 10.

Known wheelbarrow containers can be used in some embodiments. In various embodiments, the container 12 can be sized to hold about six cubic feet of material but other suitable sizes such as, for example, four cubic feet, eight cubic feet, or ten cubic feet can be utilized. The illustrated container 12 can be formed of a metal such as, for example, steel but other suitable materials can be utilized such as, for example, fiberglass or plastic. It is noted that while the container 12 is depicted in a certain manner, the container 12 can alternatively take any other forms suitable for supporting a desired load such as, for example, a flat bed, a flexible cloth or tarp, supports for retaining firewood, or the like. In one embodiment, the wheelbarrow 10 can be formed more of a hand truck using the teachings herein.

In various embodiments, the container 12 is free of openings so that it can hold fluids such as water. It is noted that a pluggable drain hole can also be provided if desired.

The wheelbarrow 10 preferably includes arms 14 and 16. The arms 14 and 16 can be connected to the frame 40 or the container 12. In various embodiments, the wheelbarrow 10 can include a resting member or leg (not shown) for propping the wheelbarrow above the ground when not in use.

The wheelbarrow includes first and second wheels 20 and 22, respectively. The wheels 20 and 22 rotate independent of one another, i.e., they do not share an axle. The first wheel 20 rotates on a wheel axle 21. The second wheel 22 rotates on wheel axle 23.

The wheels 20 and 22 are each pivotal about an axis A, which is defined by a first and second control axle 30 and 32, respectively. The first control axle 30 is connected to the wheel axle 21 via control arm 34. The second control axle 32 is connected to the wheel axle 23 via control arm 36.

The first and second control axles 30 and 32 are connected via a cable 50. The cable 50 is affixed to the first and second control axles 30 and 32 via linkages 52 and 54, respectively. In one embodiment, the cable 50 is coupled to a pully assembly 56. The pully assembly 56 can include a pin 57 and a pully bracket 58. In one embodiment, the linkages 52 and 54 are configured to connect the cable 50 to the first and second control axles 30 and 32 to transfer longitudinal movement of the cable 50 into rotational movement within the axles 30 and 32. For example, the cable 50, pulling to the left or right is converted to rotational movement within the first and second control axles 30 and 32, which pivots the control arms 34 and 36, which moves the wheels 20 and 22 up and down, i.e., converting the rotational movement within the control axles 30 and 32 to lateral movement of the wheels 20 and 22.

In one embodiment, a first spring (resilient member) 60 can be connected to the control arm 36 and the frame 40. Likewise, a second spring (resilient member) 62 can be connected to the control arm 34 and the frame 40. In this way, the springs 60 and 62 limit pivoting of the control arms 34 and 36, and therefore the wheels 20 and 22.

In operation, the cable 50 transfers movement of the control arms 34 and 36 through the pulley assembly 56, i.e., when the first control arm 34 is moved in a downward movement, the second control arm 36 is pulled upward.

For example, when a user operates the wheelbarrow 10 at a level orientation a load will remain in the same place inside of wheelbarrow container 12. When a user operates the wheelbarrow 10 over uneven ground, the wheels 20 and 22 will move accordingly to the ground but always in coordinated way, e.g., if the first wheel 20 goes up, the second wheel 22 goes down, or the opposite order.

In one embodiment, the pulley assembly 56 can be replaced with chain sprocket combination or bar and linkages to transfer wheels arms control movement. In one embodiment, a chain sprocket combination can be replaced with gyro wheel comptroller mechanism.

One skilled in the art, upon a careful reading of the teachings herein, would recognize that the disclosure could be applied to a wheelchair or hand truck application.

Additionally, examples in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A dual-wheeled wheelbarrow, comprising:
a first and a second wheel, resiliently connected together via a cable and pully assembly.

2. The wheelbarrow of claim 1, wherein the cable and pully assembly are attached to a frame.

3. The wheelbarrow of claim 1, further comprising:
a first and second control axle configured to convert longitudinal movement from the cable and pully assembly to rotational movement.

4. The wheelbarrow of claim 3, further comprising:
a first control arm connected to a first wheel axle, rotatably connected to the first wheel, and connected to the first control axle; and
a second control arm connected to a second wheel axle, rotatably connected to the second wheel, and connected to the second control axle.

5. The wheelbarrow of claim 3, wherein the first and second control arms convert the rotational movement from the first and second control axles to lateral movement of the first and second wheels.

6. The wheelbarrow of claim 4, further comprising:
a first resilient member, connecting a first end of the first control arm proximate to the first wheel axle and the frame; and
a second resilient member, connecting a first end of the second control arm proximate to the second wheel axle and the frame.

7. The wheelbarrow of claim 6, wherein the first and second resilient members are springs.

8. A dual-wheeled wheelbarrow, comprising:
a frame;
a container connected to the frame;
a first and a second wheel pivotably connected to the frame, wherein the first and second wheel are opposingly pivotable via a control axle and a cable and pully assembly.

9. The wheelbarrow of claim 8, wherein the cable and pully assembly are attached to the frame.

10. The wheelbarrow of claim 8, wherein the first and second control axle are configured to convert longitudinal movement from the cable and pully assembly to rotational movement.

11. The wheelbarrow of claim 10, further comprising:
a first control arm connected to a first wheel axle, rotatably connected to the first wheel, and connected to the first control axle; and
a second control arm connected to a second wheel axle, rotatably connected to the second wheel, and connected to the second control axle.

12. The wheelbarrow of claim 10, wherein the first and second control arms convert the rotational movement from the first and second control axles to pivotable movement of the first and second wheels.

13. The wheelbarrow of claim 11, further comprising:
a first resilient member, connecting a first end of the first control arm proximate to the first wheel axle and the frame; and
a second resilient member, connecting a first end of the second control arm proximate to the second wheel axle and the frame.

14. The wheelbarrow of claim 13, wherein the first and second resilient members are springs.

15. A dual-wheeled wheelbarrow, comprising:
a frame;
a container connected to the frame;
a first and a second wheel pivotably connected to the frame, wherein the first and second wheel are opposingly pivotable via a control axle and a cable and pully assembly.

16. The wheelbarrow of claim 15, wherein the cable and pully assembly are attached to the frame.

17. The wheelbarrow of claim 16, wherein the first and second control axle are configured to convert longitudinal movement from the cable and pully assembly to rotational movement.

18. The wheelbarrow of claim 17, further comprising:
a first control arm connected to a first wheel axle, rotatably connected to the first wheel, and connected to the first control axle; and
a second control arm connected to a second wheel axle, rotatably connected to the second wheel, and connected to the second control axle.

19. The wheelbarrow of claim 18, wherein the first and second control arms convert the rotational movement from the first and second control axles to pivotable movement of the first and second wheels.

20. The wheelbarrow of claim 19, further comprising:
a first spring, connecting a first end of the first control arm proximate to the first wheel axle and the frame; and
a second spring, connecting a first end of the second control arm proximate to the second wheel axle and the frame.
